(19) United States
(12) Patent Application Publication
(10) Pub. No.: US 2012/0092848 A1
(43) Pub. Date: Apr. 19, 2012

(54) Photographic Light

(76) Inventors: Chris Kuczynski, San Diego, CA (US); Aaron Dressin, Carlsbad, CA (US)

(21) Appl. No.: 12/903,628

(22) Filed: Oct. 13, 2010

(51) Int. Cl. G03B 15/02

(52) U.S. Cl. 362/3

(57) ABSTRACT

The embodiments and methods described are directed to a photographic light for illuminating a subject to be photographed and providing a desired reflective geometric pattern.

### TECHNICAL FIELD

The embodiments and methods described herein are generally directed to a photographic light and more particularly to a photographic light for illuminating a subject to be photographed and providing a desired reflective geometric pattern.

### BACKGROUND

Lighting accessories are commonly used in photography to illuminate a subject and provide desired effects in photographs. To achieve a desired photographic effect, various light sources are used including round lights, rectangular and square softboxes, Octabanks, ring-lights, strip lights, and umbrellas to cast a desired light on the subject including the face to either carve or accentuate some portion of the subject. A “catch light” is a term used in photography to describe a specific highlight in a subject's eyes, lips, teeth, skin, accessory, or background resulting from a reflection of a light source. A catch light helps draw attention to a desired portion of a photograph, typically the subject's eyes. Catch lights have also been used to highlight other reflective portions of a photograph including silverware, glass, metal, and the like.

A catch light is not the same as the red-eye effect caused by the reflection of light from the retina inside the back of the eyeball. The red-eye effect is caused by light from a photography flash reflected back directly into the camera lens and becomes an undesirable effect. Catch lights are aesthetically pleasing. Eyes without catch lights appear dull and lifeless.

The specific type and shape of the catch light is determined by the type, size, and shape of the light source and its distance from the subject. A typical camera speedlight will produce a small catch light while a larger Octabank will produce a larger catch light. In portrait photography, where more than one light source is used, the subject's eyes could produce two or more catch lights. A typical studio portrait photograph will show a single catch light in each of the subject's eyes in the 10 o'clock or 2 o'clock position created by the main light source.

In addition, a subject's eyes, lips, teeth, skin, accessory, or background may be used as a mirror to gain information about the surroundings of a person being photographed.

### SUMMARY

In the exemplary embodiments and methods provided herein, a photographic light is described for illuminating a subject to be photographed and providing a desired reflective geometric pattern.

### BRIEF DESCRIPTION OF THE DRAWINGS

The features and inventive aspects of the present disclosure will become more apparent upon reading the following detailed description, claims, and drawings, of which the following is a brief description:

FIG. 1 is an elevated perspective view of a first exemplary embodiment of the disclosure showing a photographic light having plurality of light sources in a general geometric shape of a heart;

FIG. 2 is a top view of FIG. 1;

FIG. 3 is a side view of FIG. 1;

FIG. 4 is a an illustration of an exemplary first orientation of the first exemplary embodiment of FIG. 1 being generally centered at eye level to the subject to be photographed;

FIG. 5 is an illustration a singular heart shaped catch light in a general pupil area of a photographed subject's eye that is produced from the first exemplary embodiment of FIG. 1 in the first orientation of FIG. 4;

FIG. 6 is an illustration of an exemplary second orientation of two heart shaped catch lights in the general pupil area of the photographed subject's eye that are produced from using two exemplary embodiments of FIG. 1 placed at the upper right and upper left camera position;

FIG. 7 is an illustration of an exemplary third orientation of the singular heart shaped catch light in the general pupil area of the photographed subject's eye that is produced from using one exemplary embodiment of FIG. 1 placed at the upper right camera position;

FIG. 8 is an illustration of an exemplary fourth orientation of the singular heart shaped catch light in the general pupil area of the photographed subject's eye that is produced from using one exemplary embodiment of FIG. 1 placed at the upper left camera position;

FIG. 9 is an elevated perspective view of a second exemplary embodiment of the disclosure showing a plurality of LED light sources placed in an exemplary rectangular shaped housing;

FIG. 10 is a front view of FIG. 9;

FIG. 11 is a side view of FIG. 9;

FIG. 12 is an elevated perspective view of a third exemplary embodiment of the disclosure showing a plurality of LED light sources placed in an exemplary rectangular shaped housing having an aperture in the housing for access to a camera lens;

FIG. 13 is a front view of FIG. 12;

FIG. 14 is an elevated perspective view of a fourth exemplary embodiment of the disclosure showing a LCD or plasma screen light source placed in an exemplary rectangular shaped housing;

FIG. 15 is an elevated perspective view of a fifth exemplary embodiment of the disclosure showing a LCD or plasma screen light source placed in an exemplary rectangular shaped housing having an aperture through the light source and housing for access to a camera lens;

FIG. 16 is an elevated perspective view of a sixth exemplary embodiment of the disclosure showing a softbox photographic light cover having a geometric pattern disposed therein;

FIG. 17 is a top view of FIG. 16; and

FIG. 18 is an elevated perspective view of FIG. 16 having an additional geometric light blocking portion.

### DETAILED DESCRIPTION

Referring now to the drawings, illustrative embodiments are shown in detail. Although the drawings represent the embodiments, the drawings are not necessarily to scale and certain features may be exaggerated to better illustrate and explain an innovative aspect of the disclosure. Further, the embodiments described herein are not intended to be exhaustive or otherwise limit or restrict the claimed invention to the precise form and configuration shown in the drawings and disclosed in the following detailed description.

The term “geometric” as used throughout the specification is defined hereinafter to exclude a round light, a rectangular softbox, a square softbox, an octabank softbox, a circular ring-light, a strip light, a strip softbox, and umbrella light, and excludes the following shapes: a circle, a square, a rectangle, and an octagon. The term “geometric” includes but is not limited to the following geometric shape(s): any singular or combination of letters, numbers, words, or symbols in any language; heart; star; any alphanumeric numeral; any symbol or trademark; company logo; company name; company trademark; reference to a place (i.e. church, bank, train station and the like); any two-dimensional likeness of a three-dimensional object (i.e. a computer, a building, a car, a book; food; clothing; and the like); a cartoon character; and an animation character.

The terms “photographic” and “photograph” and any variation thereof as used throughout the specification is defined hereinafter to include and is not limited to: the art or process of producing images of objects; the art, practice, or occupation of taking and printing photographs; of, relating to, or consisting of photography or a photograph; resembling a photograph, especially representing or simulating something with great accuracy and fidelity of detail; capable of retaining accurate or vivid impressions; like a photograph in accuracy or detail; and able to retain facts, appearances and the like in precise detail.

The terms “light” and “light source” and “illuminate” and any variation thereof as used throughout the specification is defined hereinafter to include and is not limited to: continuous or burst of electromagnetic radiation that has a wavelength in the range from about 4,000 (violet) to about 7,700 (red) angstroms and may be perceived by the normal unaided human eye; continuous or burst of electromagnetic radiation of any wavelength; an incandescent lamp or bulb; a rope light; a florescent lamp or bulb; a flash lamp or bulb; a light-emitting diode (LED); an LCD light source similar to a monitor or a laptop; a plasma light source; and the like.

One exemplary method of controlling the light intensity of LED lighting from low light to high brightness pulse lighting is described in U.S. application Ser. No. 12/331,021 entitled: “LED ARRAY FLASH FOR CAMERAS” filed Dec. 9, 2008 and is herein incorporated by reference in its entirety. Another exemplary method for controlling LED pulse light is described in U.S. Pat. No. 7,236,697 entitled: “DEVICE FOR DRIVING LIGHT EMITTING DIODE FOR FLASH CAMERA” filed Sep. 8, 2004 and is herein incorporated by reference in its entirety. An exemplary LED lighting controller for controlling lighting geometric patterns is provided in U.S. Pat. No. 7,502,0343 entitled: “LIGHT SYSTEM MANAGER” filed Nov. 22, 2004 and is herein incorporated by reference in its entirety. Another exemplary LED lighting controller is described in U.S. Pat. No. 7,737,926 entitled “DYNAMIC LED MATRIX LIGHTING CONTROL USING SCANNING ARCHITECTURE” filed Nov. 24, 2006 and is herein incorporated by reference in its entirely. However, any LED lighting controller capable of generating a LED geometric pattern or light intensity is contemplated.

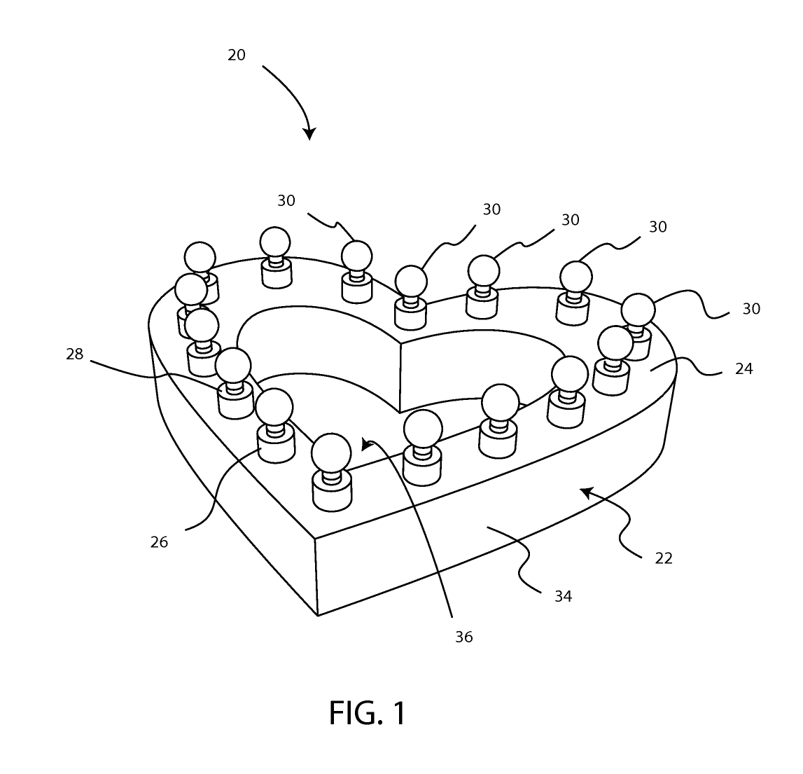

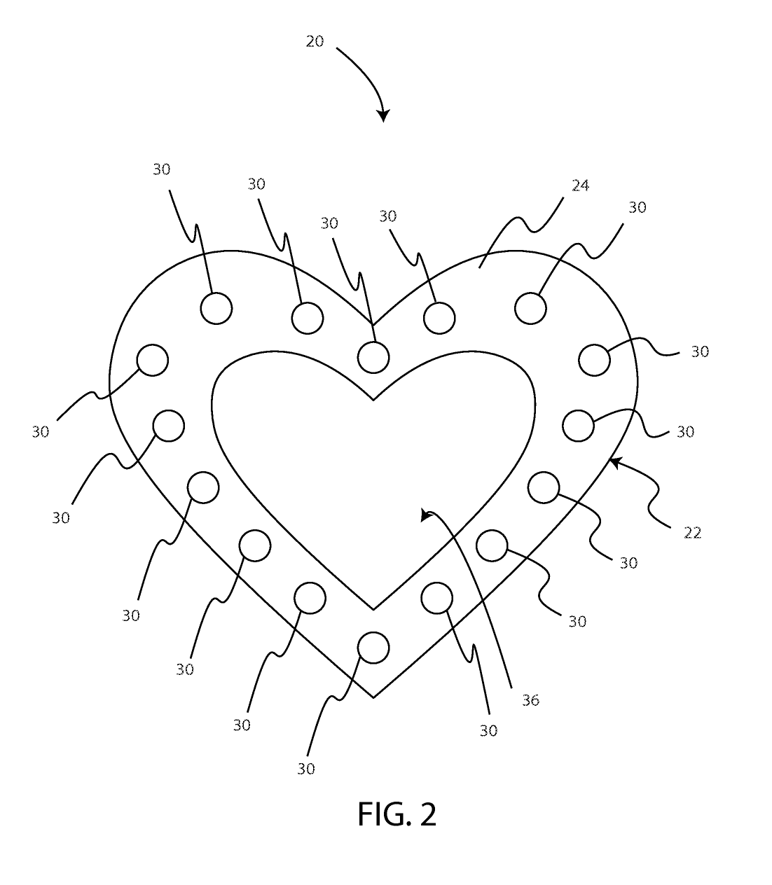

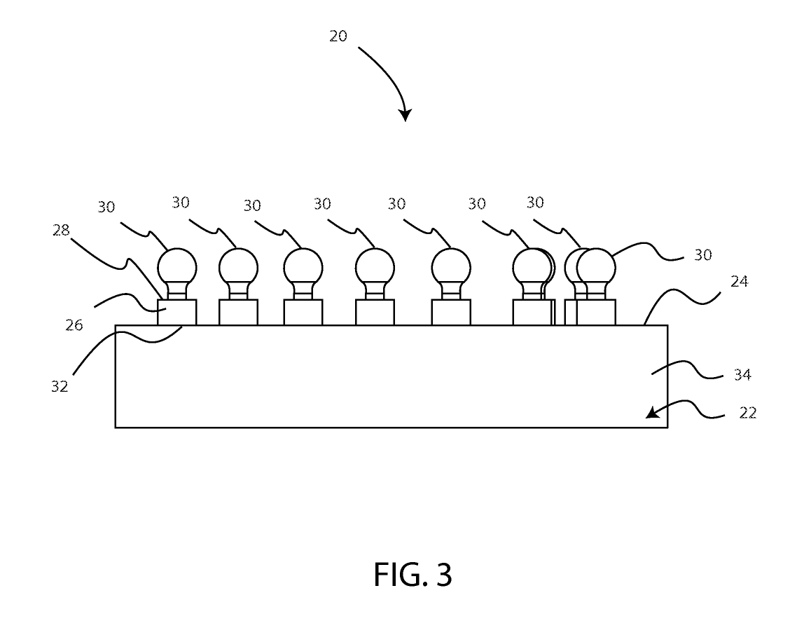

Referring to FIGS. 1-3, a first exemplary object of the disclosure according to the teaching herein is to provide a photographic light 20 having a frame 22 in a general geometric shape of a heart including a first surface 24 in mechanical communication with a plurality of electrical interfaces 26. A first portion 28 of each electrical interface 26 is adapted to be in electrical communication with at least one light source 30. The light source 30 may be any light form including a continuous form of electromagnetic radiation or a burst form of electromagnetic radiation. The light source 30 may also be an LED, LCD, or plasma form of light.

A second portion 32 of each electrical interface 26 is adapted to be in electrical communication with an electrical power source that is either a DC or AC power source. The frame 22 is shown to have at least one second surface 34 in mechanical communication with the first surface 24. An aperture 36 in the general geometric shape of the heart is also provided through the frame 22. However, the aperture 36 may be of any size and shape. The aperture 36 is adapted to allow a photographer to take a photograph of a subject through the frame 22 as further discussed below.

The frame 22 is constructed from any material sufficient to support the plurality of electrical interfaces 26 including wood, metal, ceramic, rigid fabric, plastic, cardboard, and the like. Each electrical interface 26 may be constructed from any material sufficient to provide communication between the electrical power source and the light source 30. The first exemplary photographic light 20 provided in FIGS. 1-3 shows each electrical interface 26 to be a common light bulb socket constructed from a ceramic or a plastic material insulating the metal material disposed therein; each electrical interface 26 being in electrical communication, either in serial or parallel, with the electrical power source. A selectable power switch (not shown) may be placed between the plurality of electrical interfaces 26 and the power source for selectively turning the photographic light between an “on” operational state and an “off” non-operational state.

The first exemplary photographic light 20 of FIGS. 1-3 provided illustrates the plurality of light sources 30 around the frame 22 in a geometric illumination pattern when in the “on” operational state; the light sources 30 are in the general geometric shape of the heart. However, this disclosure contemplates alternative geometric patterns including but not limited to any of the following: a letter, a number, a word, or a symbol of any language; a combination of letters, numbers, words, or symbols of any language; a heart; a star; a triangle; an alphanumeric numeral; a trademark; a company logo; a company name; a registered trademark; a two-dimensional likeness of a three-dimensional object; a two-dimensional likeness of a place; a likeness of a cartoon character; and a likeness of an animation character, and the like.

In addition, the first surface 24 of the frame 22 may be any shape or geometric pattern including but not limited to any of the following: a letter, a number, a word, or a symbol of any language; a combination of letters, numbers, words, or symbols of any language; a heart; a star; a triangle; an alphanumeric numeral; a trademark; a company logo; a company name; a registered trademark; a two-dimensional likeness of a three-dimensional object; a two-dimensional likeness of a place; a likeness of a cartoon character; and a likeness of an animation character, and the like. When a plurality of light sources 30 are placed along the geometric pattern of the first surface 24, an illuminated outline of the first surface 24 is provided.

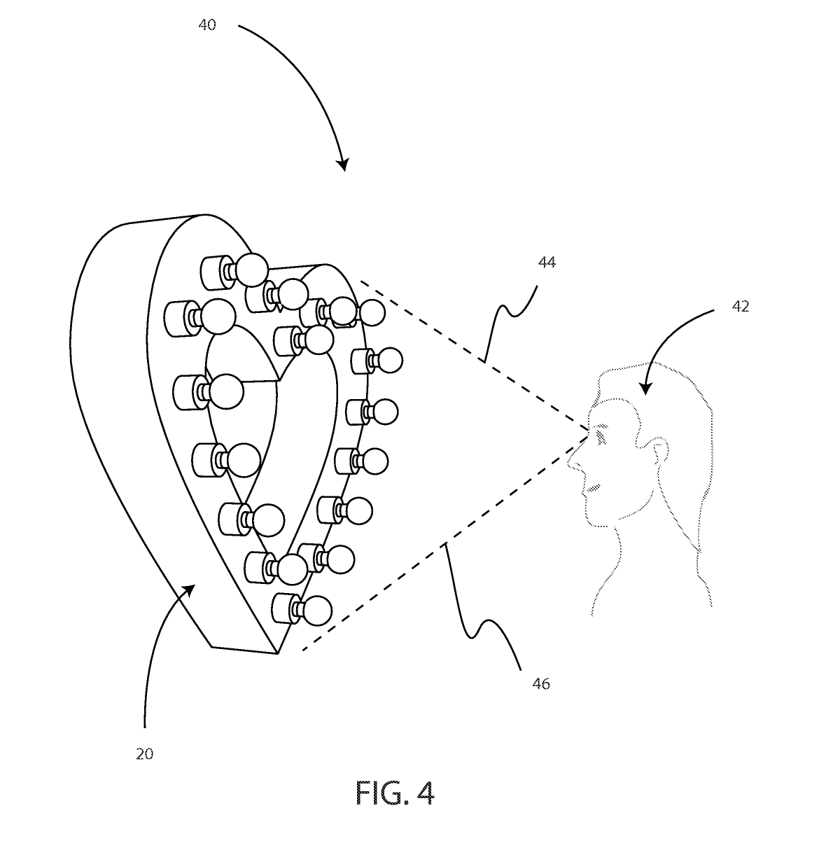

Referring to FIG. 4, an exemplary first orientation 40 of the photographic light 20 is illustrated having the photographic light 20 in an position generally centered at eye level to the subject to be photographed 42. In the exemplary first orientation 40, the photographic light 20 is placed such that the light source 30 is generally facing the subject to be photographed 42 at approximately eye level such that the upper eye angle 44 is generally equal to the lower eye angle 46. However, the photographic light 20 may be placed in any position and orientation to provide a catch light on the subject to be photographed. The exemplary first orientation 40 is desirable to achieve the catch light look of FIG. 5 reflecting from the subject to be photographed 42 eyes.

FIG. 5 illustrates a singular heart shaped catch light 48 in the general pupil area 50 of a photographed subject's eye 52 that is produced from the heart shaped photographic light 20 of FIGS. 1-3 in the first orientation 40 of FIG. 4. A photograph is taken by the photographer standing on the opposite side of the photographic light 20 from the light source 30 shooting through the aperture 36. It is contemplated that a camera lens may be placed so that it is possible to shoot through the aperture 36. In addition, automatic photographs of the subject are possible producing the same effect in a photo booth device (not shown).

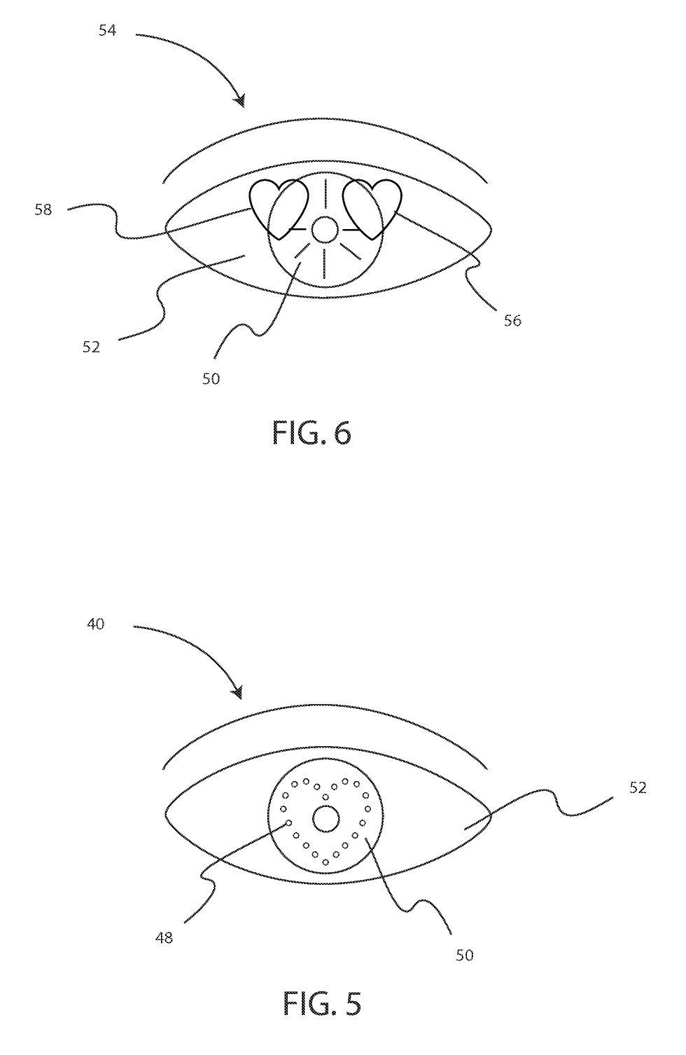

Referring to FIG. 6, an exemplary second orientation 54 of two photographic lights 20 is illustrated. One photographic light 20 is placed to the right of the camera producing a first catch light at the general 2 o'clock area 56 of the pupil area 50 of the subject's eye 52 and a second photographic light 20 is placed to the left of the camera producing a second catch light at the general 10 o'clock area 58 of the pupil area 50 of the subject's eye 52. The catch light is also reflected from any other reflective surface in the photograph.

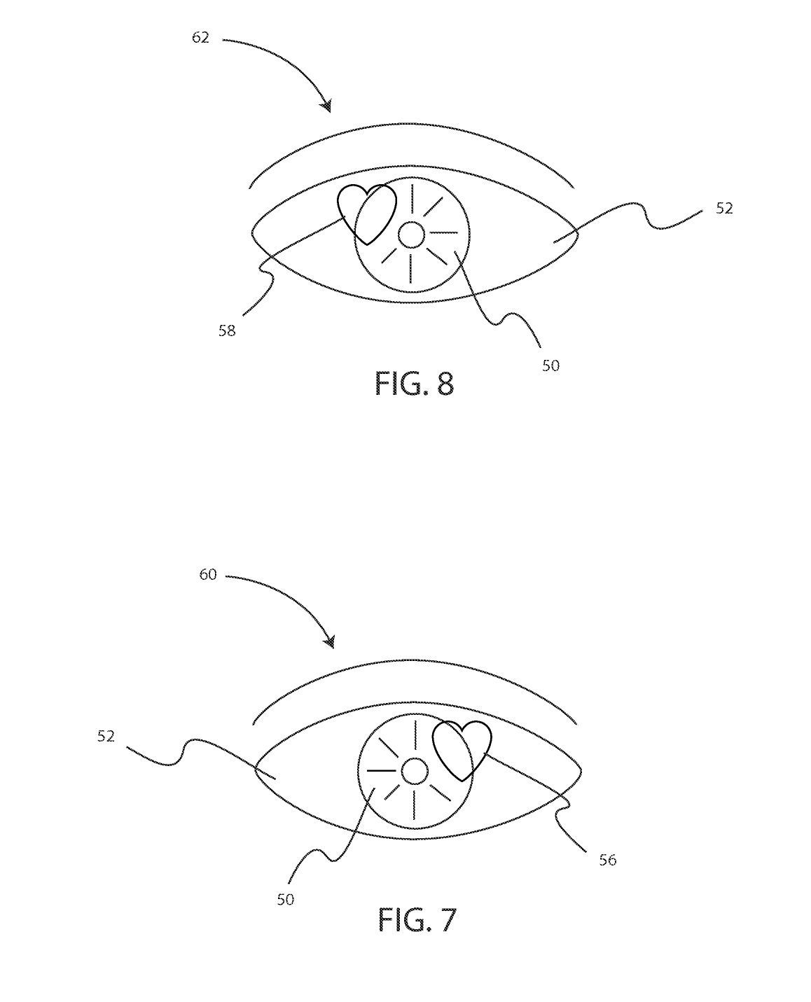

FIG. 7 illustrates an exemplary third orientation 60 of one photographic light 20 placed generally to the right of the camera when photographing a subject to produce a catch light at the general 2 o'clock area 56 of the pupil area 50 of the subject's eye 52. The catch light is also reflected from any other reflective surface in the photograph.

FIG. 8 illustrates an exemplary fourth orientation 62 of one photographic light 20 placed generally to the left of the camera when photographing a subject to produce a catch light at the general 10 o'clock area 58 of the pupil 50 of the subject's eye 52. The catch light is also reflected from any other reflective surface in the photograph.

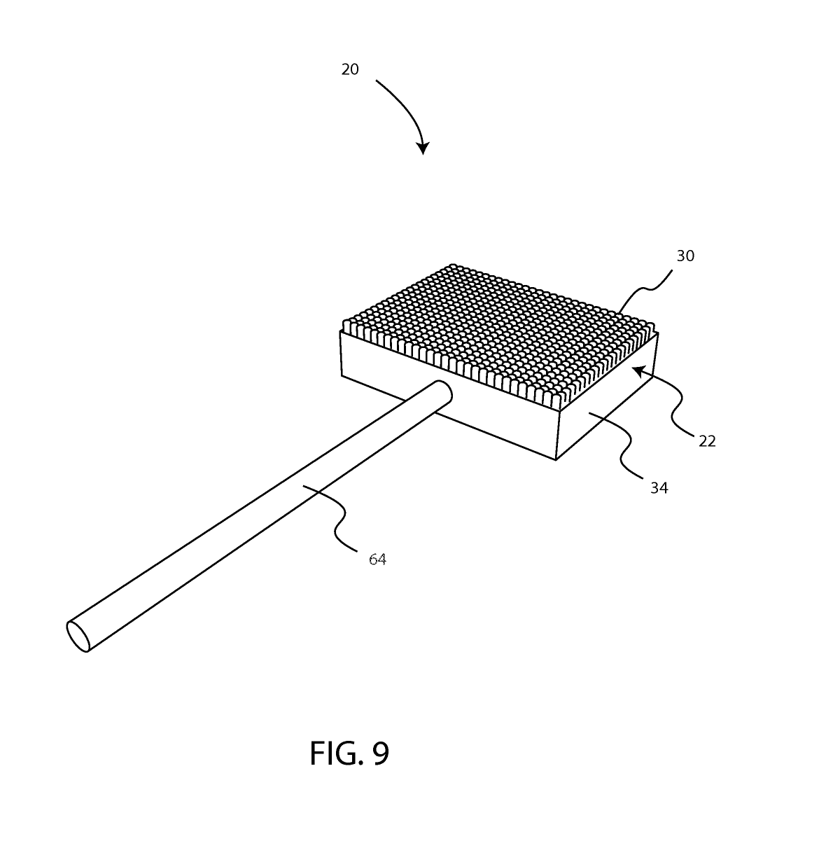

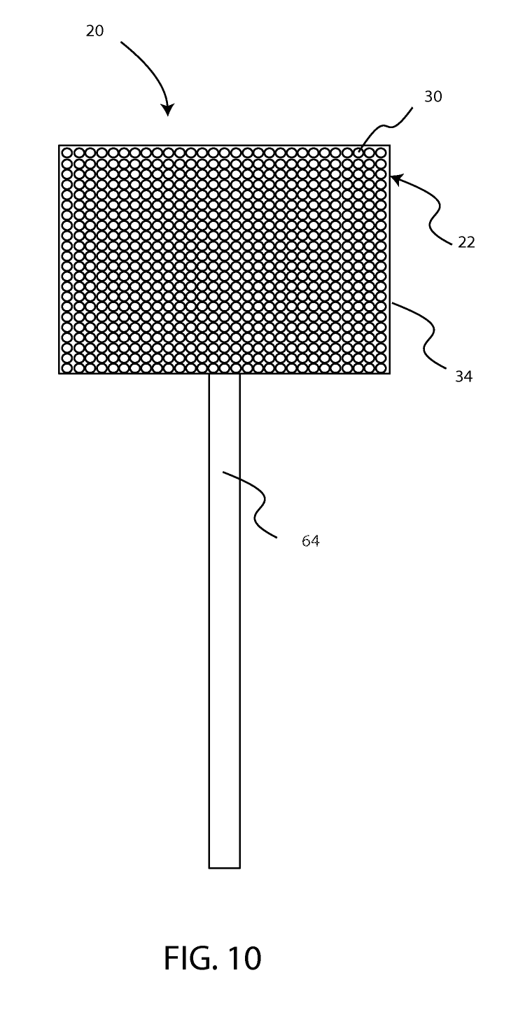

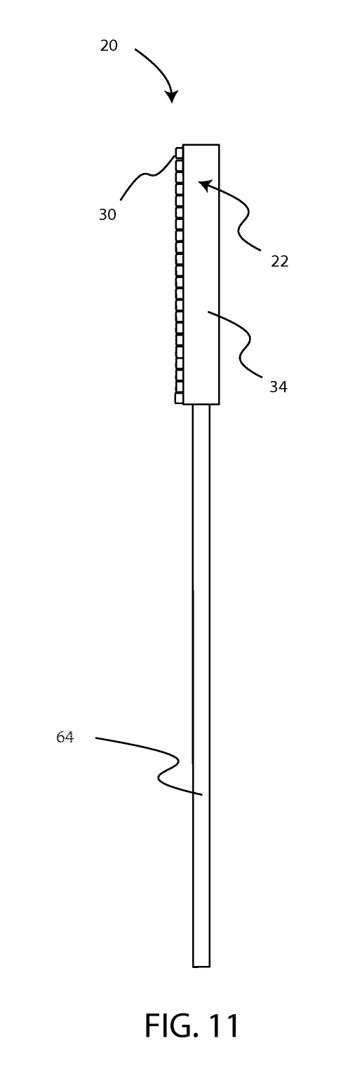

FIGS. 9-11 illustrate a second exemplary embodiment of photographic light 20 the disclosure showing a plurality of LED light sources 30 placed in an exemplary rectangular shaped frame 22. The LED light sources 30 are in mechanical communication with the frame 22 and in electrical communication with the power source. The LED light sources 30 may be either continuous or burst form of light. The LED light sources 30 may also be continuous form of light with a burst of higher intensity light when taking a photograph. The geometric pattern may be controlled by any type of selective geometric pattern controller used to generate a desired geometric pattern including but not limited to a LED pattern controller (not shown).

The geometric pattern controller may also be any computer, video playing device, image playing device, or any type of machine with electrical processing capabilities including but not limited to video or data processing and/or streaming The second surface 34 provides the frame 22 with support for a stand portion 64 for selectively adjusting the height of the photographic light 20.

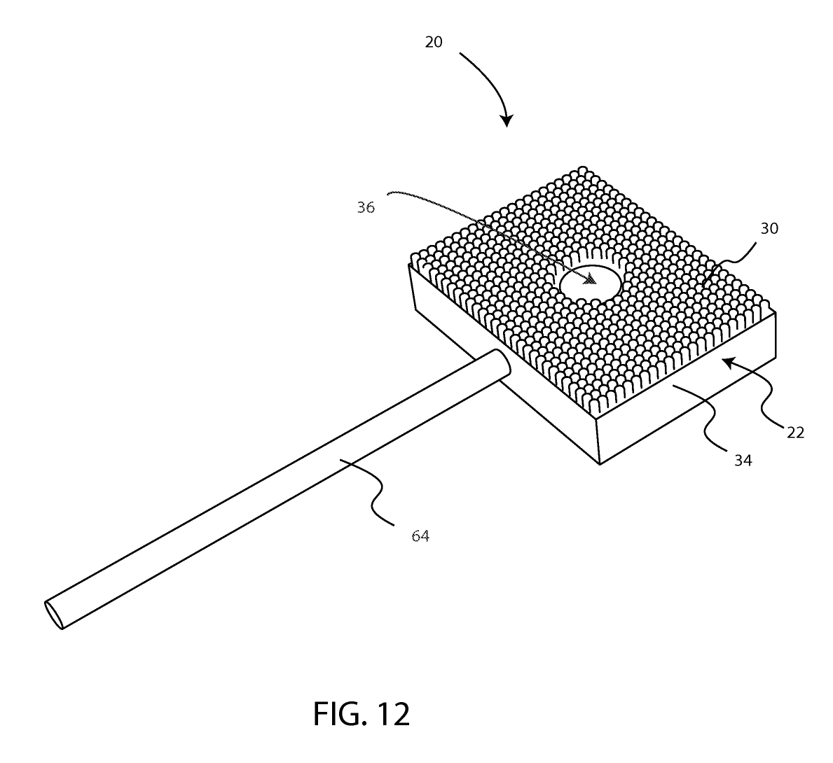

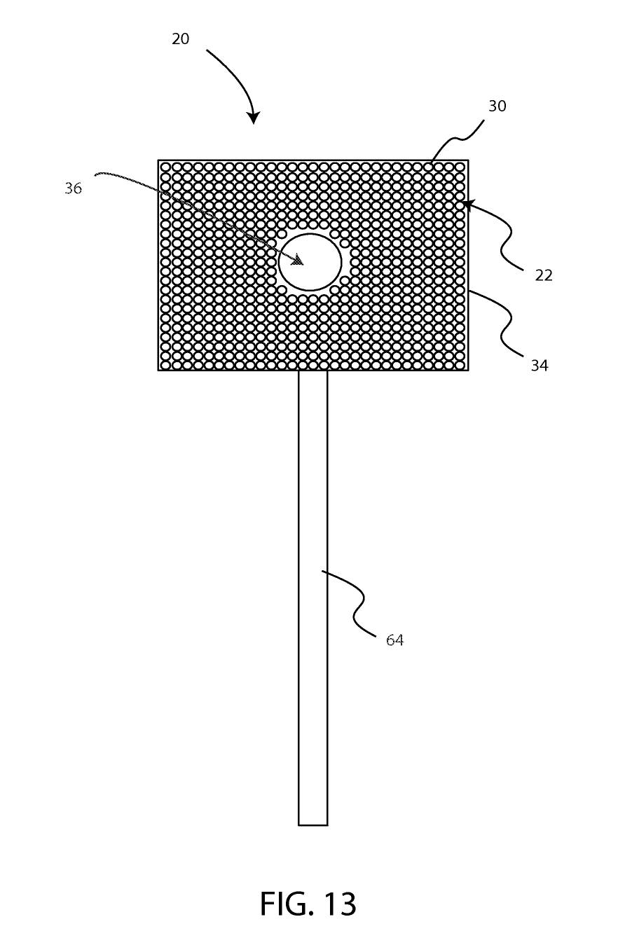

FIGS. 12-13 illustrate an elevated perspective view of a third exemplary embodiment of the photographic light 20 showing the second exemplary embodiment of FIGS. 9-11 with the aperture 36 for photographing the subject in the first exemplary orientation of FIG. 4.

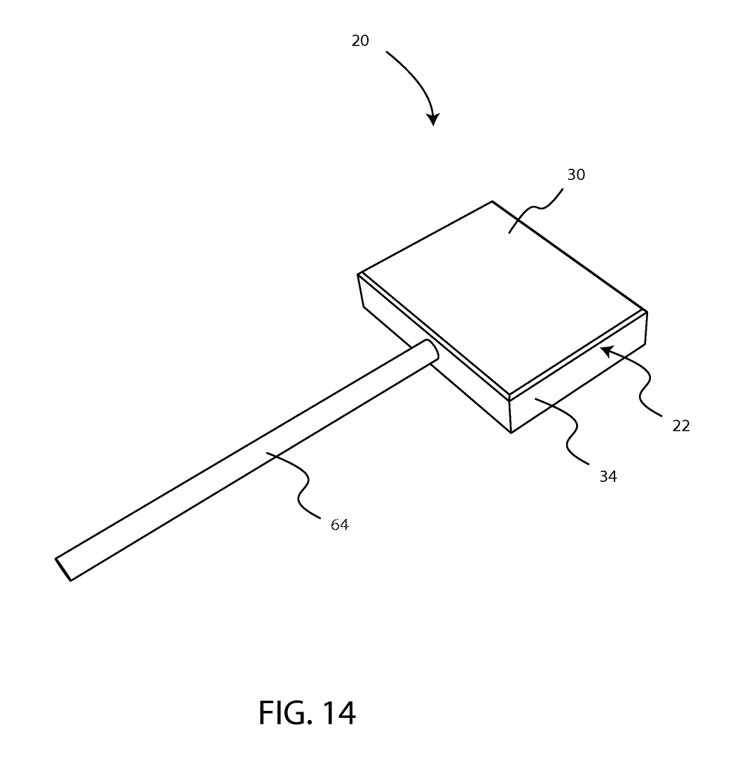

FIG. 14 illustrates a fourth exemplary embodiment of the photographic light 20 showing a LCD or plasma screen light source 30 placed in an exemplary rectangular shaped frame 22. The LCD or plasma screen 30 is in mechanical communication with the frame 22 and in electrical communication with the power source. The LCD or plasma screen 30 may be either continuous or burst form of light. The LCD or plasma screen 30 may also be continuous form of light with a burst of higher intensity light when taking a photograph. The geometric pattern may be controlled by any type of selective geometric pattern controller used to generate a desired geometric pattern. The geometric pattern controller may also be any computer, video playing device, image playing device, or any type of machine with electrical processing capabilities including but not limited to video or data processing and/or streaming The second surface 34 provides the frame 22 with support for the stand portion 64 for selectively adjusting the height of the photographic light 20.

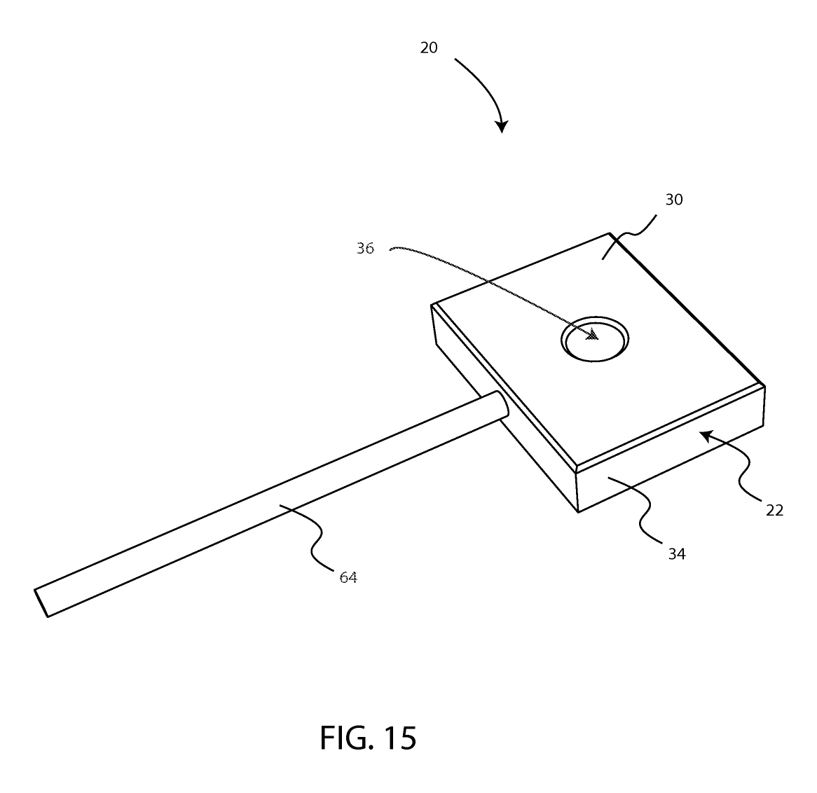

FIG. 15 illustrate an elevated perspective view of a fifth exemplary embodiment of the photographic light 20 showing the fourth exemplary embodiment of FIG. 14 with the aperture 36 for photographing the subject in the first exemplary orientation of FIG. 4.

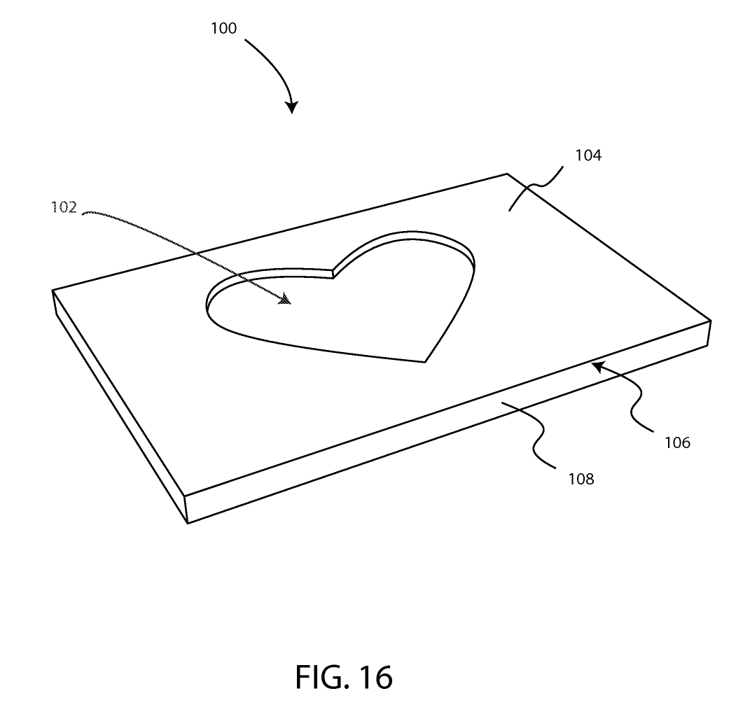

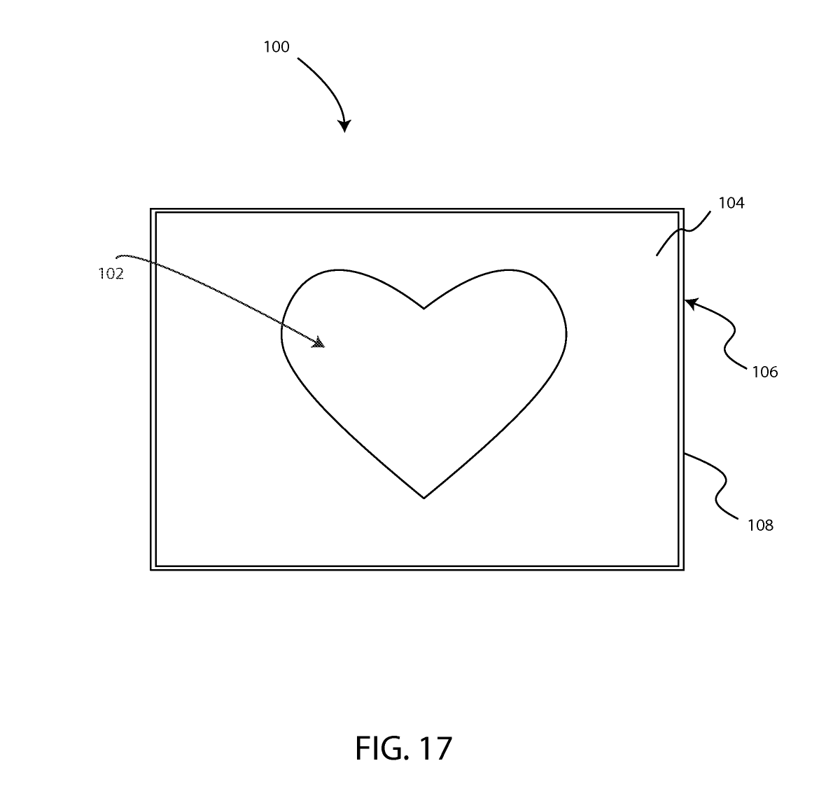

FIGS. 16-17 provides an illustration of a sixth exemplary embodiment of the disclosure showing a photographic light cover 100 having a geometric pattern 102 disposed on a first surface 104 of a cover substrate 106. The cover substrate 106 is selected from a material that generally does not allow light to pass and may be constructed from any type of material including a soft material like fabric or a hard material like plastic, metal, cardboard, and the like. The geometric pattern 102 may be a void or any type of translucent or transparent material including but not limited to fabric, plastic, or glass. The cover substrate 106 may be adapted to be selectively placed over any type of softbox of any shape and size so that the photographic light cover 100 blocks light from the softbox except for the geometric pattern 102 of the photographic cover light 100 providing a catch light on the subject to be photographed as described above. The photographic light cover 100 may be secured to the softbox by any type of securing method including but not limited to Velcro at any portion of a cover perimeter 108.

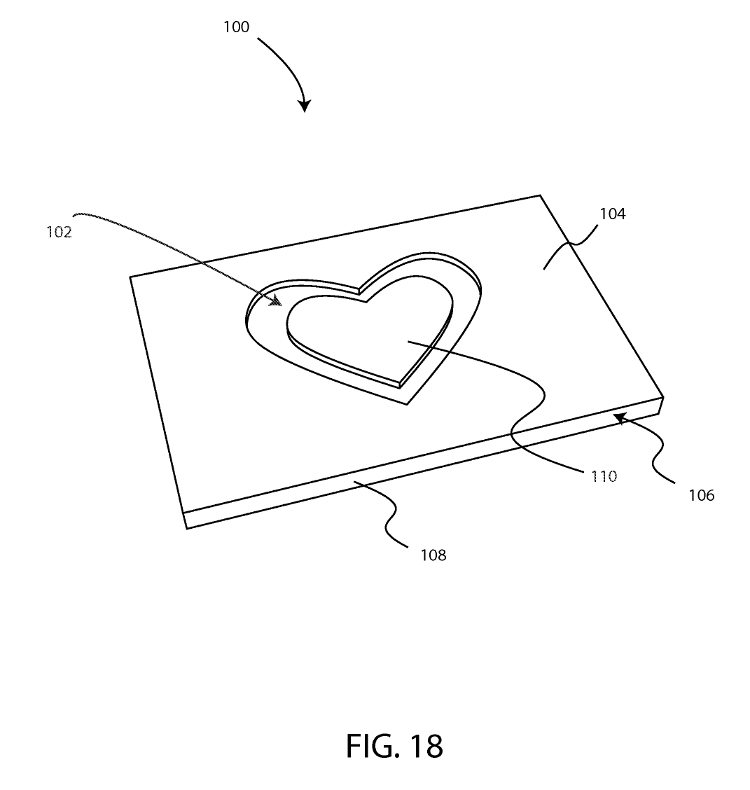

FIG. 18 illustrates the embodiment of FIGS. 16-17 having an additional geometric light blocking portion 108 disposed within the geometric pattern 102.

Referring to FIGS. 1-15, a method of providing a photographic light 20 is also contemplated including the steps of providing a frame having a first surface 24 in mechanical communication with at least one electrical interface 26. Configuring a first portion 28 of the at least one electrical interface to be in electrical communication with at least one light source 30. Configuring a second portion 32 of the at least one electrical interface 26 to be in electrical communication with a power source. Placing the at least one light source 30 in a geometric illumination pattern so that at least one portion of one subject to be photographed reflects the geometric illumination pattern.

Providing an aperture 36 disposed on the first surface 24 of the frame 22 adapted to allow a photographer to photograph the subject to be photographed through the aperture.

The geometric pattern is selected from a group consisting of: a letter, a number, a word, or a symbol of any language; a combination of letters, numbers, words, or symbols of any language; a heart; a star; a triangle; an alphanumeric numeral; a trademark; a company logo; a company name; a registered trademark; a two-dimensional likeness of a three-dimensional object; a two-dimensional likeness of a place; and a likeness of a cartoon character.

Shaping the first surface 24 of the frame 22 in a geometric pattern selected from a group consisting of: a letter, a number, a word, or a symbol of any language; a combination of letters, numbers, words, or symbols of any language; a heart; a star; a triangle; an alphanumeric numeral; a trademark; a company logo; a company name; a registered trademark; a two-dimensional likeness of a three-dimensional object; a two-dimensional likeness of a place; and a likeness of a cartoon character.

The preceding description has been presented only to illustrate and describe exemplary embodiments of the methods and systems of the present disclosure. It is not intended to be exhaustive or to limit the invention to any precise form disclosed. It will be understood by those skilled in the art that various changes may be made and equivalents may be substituted for elements thereof without departing from the scope of the claimed invention. In addition, many modifications may be made to adapt a particular situation or material to the teachings of the disclosure without departing from the essential scope. Therefore, it is intended that the claimed invention not be limited to the particular embodiment disclosed as the best mode contemplated for carrying out the claimed invention, but that the claimed invention will include all embodiments falling within the scope of the claims. The disclosure may be practiced otherwise than is specifically explained and illustrated without departing from its spirit or scope. The scope of the claimed invention is limited solely by the following claims.

1. A photographic light comprising:
a frame having a first surface in mechanical communication with at least one electrical interface; a first portion of said at least one electrical interface being for electrical communication with at least one light source; a second portion of said at least one electrical interface being for electrical communication with a power source; and
said at least one light source is placed in at least one geometric shape selected from a group consisting of a heart; a star; and a triangle.

2. (canceled)

3. (canceled)

4. (canceled)

5. (canceled)

6. (canceled)

7. (canceled)

8. The photographic light of claim 1, wherein said at least one light source is at least one form of a continuous form or a burst form of electromagnetic radiation.

9. (canceled)

10. (canceled)

11. (canceled)

12. (canceled)

13. (canceled)

14. (canceled)

15. (canceled)

16. (canceled)

17. (canceled)

18. A method comprising the steps of:
providing a frame having a first surface in mechanical communication with at least one electrical interface;
placing a first portion of said at least one electrical interface to be in electrical communication with at least one light source;
placing a second portion of said at least one electrical interface to be in electrical communication with a power source; and
placing said at least one light source in a geometric shape selected from a group consisting of: a heart; a star; a triangle, a likeness of a cartoon character, a likeness of an animation character; and at least one word having at least two spaced apart letters.

19. (canceled)

20. (canceled)

21. (canceled)

22. (canceled)

23. (canceled)

24. (canceled)

25. (canceled)

26. A photograph made according to the method of claim 18.

27. A photographic light comprising:
a frame having a first surface in mechanical communication with at least one electrical interface; a first portion of said at least one electrical interface being for electrical communication with at least one light source; a second portion of said at least one electrical interface being for electrical communication with a power source; and
at least one light source is placed in at least one a geometric shape is a graphic trademark or a combination of spaced apart letters wherein said combination of letters are both illuminated in a burst form or a continuous form of an electromagnetic radiation for making a photograph.
